(19) United States
(12) Patent Application Publication
(10) Pub. No.: US 2026/0133977 A1
(43) Pub. Date: May 14, 2026

(54) USER CONTENT AGGREGATION

(71) Applicant: Notion Labs, Inc., San Francisco, CA (US)

(72) Inventors: Marina Schimidinger Camim, San Francisco, CA (US); Ken Chen, San Francisco, CA (US); Aziz Michael Batihk, San Francisco, CA (US); Saatchi Bhalla, San Francisco, CA (US); Chenyang Wu, San Francisco, CA (US)

(21) Appl. No.: 18/980,142

(22) Filed: Dec. 13, 2024

Related U.S. Application Data
(60) Provisional application No. 63/718,521, filed on Nov. 8, 2024.

(51) Int. Cl. G06F 16/2457; G06F 16/27; G06F 16/28

(52) U.S. Cl. CPC G06F 16/2457; G06F 16/27; G06F 16/287

(57) ABSTRACT

Described herein are systems, methods, and devices that can be used to aggregate user-specific content across multiple databases. In some implementations, databases within a specified scope are included in the aggregated view. The databases can comprise data used to populate one or more blocks of an integrated workspace, each block comprises one or more properties. The one or more properties can comprise at least one common property. The scope can be a grouping of hierarchically organized blocks of a render tree. The user-specific content can include, for example, tasks, projects, and/or wiki pages.

### CROSS-REFERENCE TO RELATED APPLICATIONS

This application claims the benefit of priority to U.S. Provisional Application No. 63/718,521, filed Nov. 8, 2024, which is incorporated by reference herein in its entirety.

### BACKGROUND

Integrated workspaces can be powerful tools for organizing information, managing tasks, and so forth. However, difficulties can arise when there is a need to view information that is spread across multiple sources. Existing approaches to aggregating information can require technical skill and be difficult to maintain. Accordingly, there is a need for improved approaches to aggregating data across multiple data sources.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 is a flowchart that illustrates an example process for generating an aggregated view of database items according to some implementations.

FIG. 5 is a flowchart that illustrates an example process for converting databases according to some implementations.

FIG. 6 is a diagram that illustrates an example process for updating a mapping according to some implementations.

FIG. 7 is a drawing that illustrates an example of user-specific database aggregation according to some implementations.

FIG. 8 is a drawing that illustrates an example database conversion user interface according to some implementations.

FIG. 9 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Integrated workspaces offer a powerful tool for organizations, teams, and even individuals to collect knowledge, organize information, manage tasks, manage projects, and so forth. However, it can be difficult for users to identify content that is relevant to them or for which they have some responsibility or need to take some action. For example, a user may have tasks that are spread throughout various locations in the integrated workspace, for example in different projects, teamspaces, etc. As another example, a user may have various documents (e.g., wiki pages) that they are responsible for maintaining but may lack a way to see a unified view of those documents across the integrated workspace.

Users can resort to manually looking through various pages, projects, etc., to identify what is relevant to them, or more advanced users may create a page that includes views from various databases. However, such solutions are time-consuming, potentially confusing or beyond the skillset of users, and can become incomplete, outdated, and/or broken as databases, pages, etc., are added, deleted, and/or modified within the integrated workspace.

These difficulties can have significant impacts. For example, a user may miss deadlines for tasks, fail to maintain pages they are responsible for, and so forth. Accordingly, there is a need for approaches that can present user-specific information in a clear manner and without requiring a large degree of technical knowledge about the integrated workspace or requiring users to manually create views, search for relevant items in the integrated workspace, and so forth.

The present disclosure describes approaches for aggregating user-specific content across multiple data sources (e.g., databases or database tables). In some implementations, the multiple data sources are logically within an integrated workspace. In some implementations, multiple data sources are within different portions of an integrated workspace, such as different teamspaces (e.g., a space shared by multiple users on a team) and/or personal spaces (e.g., a space only accessible to a particular user). User-specific content can include, for example, tasks assigned to the user, projects or project components assigned to the user, pages authored by the user, meeting notes created by the user or in which the user is mentioned, wiki pages owned by the user, and so forth. For ease of understanding, the following disclosure is provided largely in terms of tasks and task databases. However, it will be appreciated that the approaches described herein can be readily adapted to documents, pages, wiki pages, meeting notes, projects, or any other type of data within an integrated workspace that is associated with a particular user.

In some implementations, tasks can be stored in task databases (e.g., databases with a “task” database type, as described in more detail herein). There can be a plurality of task databases that contain tasks for a user (and potentially for multiple users). For example, the user may have their personal tasks (e.g., tasks the user creates for themself), tasks associated with particular projects, tasks associated with particular teams, and so forth. As an example, a manager may have tasks associated with particular projects the manager is supervising, HR tasks for managing employees, and their own personal tasks, which can be stored in different task databases.

In some implementations, databases can have database types. Database types can include, for example, project, task, document, meeting, wiki, sprint, people, etc. A database type can define certain aspects of the database such as certain properties (also referred to as fields) that exist in the database. In some implementations, a database is a user-defined database and may not have a type associated therewith or may have a user-defined type. The type of a database can have implications for other functionality, such as building charts or timelines, generating notifications, and so forth. Database types can be useful for identifying which databases in an integrated workspace should be included with generating aggregated views of content (e.g., aggregated views of user-specific content).

Databases, as used herein, are not limited to traditional relational databases, though such databases are within the scope of this disclosure. In some implementations, a database can be a collection of blocks in an integrated workspace. An integrated workspace can be divided into multiple spaces (e.g., teamspaces for particular teams, personal spaces). The integrated workspace can include documents, pages, projects, wikis, etc., which can also be made up at least partially of blocks. A database itself can be or can include a block and can include other blocks in the integrated workspace. A block can have one or more properties associated therewith. In some implementations, properties are grouped into different categories. For example, some properties can be required core properties. In some implementations, required core properties are properties that are required for a block to have a particular type. For example, all blocks in a database with a particular database type must include the required core properties for that database type (e.g., all task blocks in a task database must have the required core properties for a task database). In some cases, not all required core properties are populated with a value. For example, if “assignee” is a required core property for a task in a database with a “task” type, a task block can include the assignee property, but the property may not be populated with a value. In some implementations, database types include optional core properties. Optional core properties can be pre-defined properties that may or may not be present in a block having a particular block type. In some implementations, a user can define one or more user-defined properties that are included in a block having a user-defined block type or a system-defined block type (e.g., a user can add additional properties to tasks in a task database). In some implementations, users can create custom databases and can define required core properties, optional core properties, or both for a user-defined block type or user-defined database type. In some implementations, certain properties may be automatically populated with values. For example, if a user creates a task list in their personal space, tasks can be automatically assigned to the user without the user necessarily having to specify the assignee. In some implementations, certain properties may be hidden in a default view. Continuing with the personal tasks example, the assignee property may be hidden as it is likely of little value to the user.

In some implementations, a system can be configured to aggregate blocks from multiple databases and to provide an aggregated view of blocks from the multiple databases (e.g., to aggregate database records (also referred to as database items) across multiple databases). In some implementations, the system can provide automatic or manual harmonization of databases, in which properties of blocks in one database are mapped to properties of blocks in another database or to required properties for a database type. For example, if a first database has a “due date” property and a second database has a property called “due” and both accept a date, the system can infer that “due date” and “due” both refer to a due date. In some implementations, the system displays an inferred property mapping to a user, and the user can confirm the mapping, reject the mapping, and/or modify the mapping. In some implementations, mappings to not alter the underlying database. For example, if “due” is mapped to “due date” for purposes of aggregation, the property can still be named “due” in the underlying database, even though it is labeled as “Due Date” in an aggregated view. In some implementations, underlying property names can be changed, for example when a database is converted from one type (or untyped) to another type.

In some implementations, the integrated workspace platform enables aggregation of databases with different types and/or of untyped databases. In some implementations, only databases that share the same type can be aggregated. This can offer several advantages. For example, by requiring that databases have the same type in order to be aggregated, aggregation of different kinds of data, which can be confusing or make aggregated views less useful, can be avoided. In some implementations, as described herein, the integrated workspace platform includes functionality for users or database owners to convert databases from one type to another type, or from untyped to typed.

While a platform can provide for databases with system-defined types and system-defined properties, the present disclosure is not limited to databases that have system-defined types. In some implementations, a user can create user-defined databases. In some implementations, users can create user-defined database types. As one example, a teacher can create a database of students for each of their classes. For example, a teacher can create a page for each class, and within each page, the teacher can add a database that includes the students in that class. In some cases, the teacher may want to view all the students from all their classes together in an aggregated view. In some implementations, a platform is configured to allow aggregation of all or a subset of databases, which can include user-defined database types. For example, the platform can be configured to aggregate all or some student databases.

In some implementations, a system is configured to enable users to convert databases between different database types, or from untyped to typed. For example, if a user creates a custom database to track their tasks, the user may subsequently convert the custom database to a task database. For example, the user can indicate which properties of the custom database map to required properties for a task database. In some cases, the system can enable the user to create new properties, for example, if the custom database does not have a property that corresponds to a required property for the database type.

In some implementations, a block model as described herein can provide certain advantages. For example, a database can be a block that comprises multiple blocks or that is associated with multiple blocks. Each block in the database can itself comprise one or more blocks. Each block and/or the properties thereof can have a unique identifier or quasi-unique identifier (e.g., an internal identifier) that does not change over time, even if a user-facing identifier (e.g., database, property name) changes. In some implementations, an aggregated view can make use of unique identifiers rather than names for purposes of determining which databases, properties, etc., should be included in an aggregated view. Thus, even if a user changes the name of a property or database, the aggregated view can continue to operate normally and without interruption. In essence, a database or property can have an underlying “name” that is typically not displayed to users and which can be used for internal processing operations, and a friendly “name” that users see and can edit in some cases.

In some implementations, a system can be configured to automatically aggregate databases having a particular type. For example, a system can be configured to aggregate all “task” databases or all “project” databases in a scope (e.g., within a workspace, within a teamspace, etc.). As used herein, a scope can be a collection of databases or blocks within the render tree, for example databases or blocks within a workspace, teamspace, etc. For example, a user's personal space can include a landing page that includes default blocks. A default block can be, for example, an aggregated task view showing the user's assigned tasks.

In some implementations, a system is configured to aggregate all database items in certain databases. In some implementations, the system applies one or more filters when creating an aggregated view. For example, the system can be configured to aggregate and filter tasks across multiple task databases in order to display a list of all of a user's tasks in the user's personal home or landing page. For example, the aggregated view shown to the user can show only blocks or database items where the user is mentioned, such as only tasks that are assigned to the user. In some implementations, users can exclude one or more databases from an aggregated view. For example, a user may want to keep their personal tasks separate from tasks that are included in projects, teamspaces, etc.

In some implementations, an aggregated view may display a subset of properties. For example, certain properties may be excluded from a default aggregated view. In some implementations, a user can click on or otherwise select an item in aggregated view. For example, an aggregated view can be a table, and the user can click on a row in the table to display additional properties that are not displayed into the table itself. In some implementations, the aggregated view includes only properties from the underlying databases. In some implementations, the aggregated view includes other information. For example, the aggregated view can include a column that indicates which database a particular record is located in. In some implementations, a user can click on or otherwise interact with the indication of the underlying database for a particular record to open up a view of the underlying database associated with the record.

Various approaches exist for aggregating tasks or other information. However, current approaches have significant drawbacks. In one approach, all data that has a particular field or property is aggregated. For example, a platform can generate an aggregated view that includes all data with a “status” field. However, such an approach can be of little or no utility and can be frustrating to users. For example, many different types of information can include a “status.” For example, a task can have a status (e.g., not started, in progress, under review, complete) and a document can have a status (e.g., reviewed, approved, under review, deprecated, etc.). An aggregated view that shows both pages and tasks in the same view can provide limited utility. Moreover, users may create custom data structures, which can also be undesirably aggregated.

In another approach, a platform does not allow users to create custom data structures or generic databases. This can make aggregation relatively easy, but such restrictions can make the platform confusing or ill-suited to certain use cases. For example, a platform that uses task data structures intended for software developers can include fields such as a link to a repository for accessing source code. If the platform is used by non-developers, such fields may be of little or no use and can add unnecessary and potentially confusing clutter to a user interface.

Advantageously, the approaches described herein can utilize database typing to aggregate databases, thereby ensuring that, for example, an aggregated task list isn't cluttered with non-task items. Moreover, users or administrators can configure databases, for example by adding custom properties, or even to create entirely custom-defined databases. This flexibility allows databases to be customized for their particular purpose. For example, a task database for developers and a task database for a legal department can include common properties (e.g., assignee, status, due date) while also including custom properties that are relevant to each particular use case. For example, the task database for developers can include properties such as a code repository link, while the task database for the legal team can include properties such as outstanding budget. name of outside counsel, and so forth.

There are significant challenges associated with aggregating databases. For example, when a user requests an aggregated view, if a platform has to query multiple databases to identify which database items to include in the aggregated view, there can be significant server load and/or significant delays in generating the aggregated view, resulting in a need for greater computing resources and/or user frustration as users have to wait for aggregated views to be generated. In some implementations, mapping can be used to speed up requests for aggregated views. For example, in the context of a user-specific tasks aggregation, a platform can generate a mapping of assignees and tasks. When a user requests an aggregated view of all tasks assigned to them, the platform can query the mapping, rather than searching each database individually to determine which tasks are assigned to the user. This can significantly improve performance and reduce the time taken to generate an aggregated view. In some implementations, the mapping can be stored in memory, for example in an in-memory database.

In some implementations, the in-memory mapping is generated when a user first requests an aggregated view. In some implementations, the in-memory mapping is generated for all users (e.g., all assignees) when a user requests an aggregated view. When a second user requests an aggregated view, the platform can query the existing in-memory mapping, without needing to generate a new or updated mapping for the second user. The platform can be configured to update the mapping as tasks are added or deleted.

One advantage of the integrated workspace described herein is the ease of creating new databases. For example, a team may set up a teamspace for a new project and add one or more databases within the teamspace, or users may add new databases within an existing workspace, teamspace, personal space, etc. Thus, the specific databases that are to be aggregated can change over time, in some cases rapidly. In some implementations, a platform can detect when a new database of a particular type is added (e.g., a new or converted task database) and can update the in-memory mapping to include the new database (e.g., to map tasks in the new database to assignees).

In some implementations, databases can have hidden properties. Hidden properties exist and may be populated with values, but it can be desirable not to show them to the user. For example, if a user creates a database of personal tasks in their personal space, there is likely little or no benefit to showing assignee since the user created the personal tasks for themself, but assignee may generally be a required property for a task database. When aggregating databases, the assignee property may be required. Thus, in some implementations, the user's personal tasks database can include an assignee property but the property may not typically be shown to the user. Similarly, assignor can be a useful property for task databases included in a teamspace but have little or no value for a personal tasks list as the user is both the assignor and assignee.

In some implementations, updates to the aggregated view are processed by a server. In other implementations, updates to the aggregated view are processed by a client application (e.g., a desktop application, mobile application, or an application running in a web browser). Different approaches to updating the aggregated view can be used under different circumstances. For example, for relatively small views, filtering, sorting, processing new or updated blocks, etc., can be done on a client. For larger databases, such processes can be performed by a server. As an example, for a small database, if a new block is added, a server can send the block to the client, and the client can determine how to update any views or otherwise process the new block. For a large database, the server can notify the client that a new block has been added, and the client can contact the server to find out what the block is, how to process it, etc. As another example, filtering or sorting of a relatively small database can be performed on the client, while for a larger database, server-side processing may be preferable (e.g., to avoid transmitting large volumes of unnecessary data to the client and/or to avoid putting heavy processing demands on a client system).

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. Save Transactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

It will be appreciated that the above description is merely for illustration, and the specific technologies used can vary.

### Software Platform

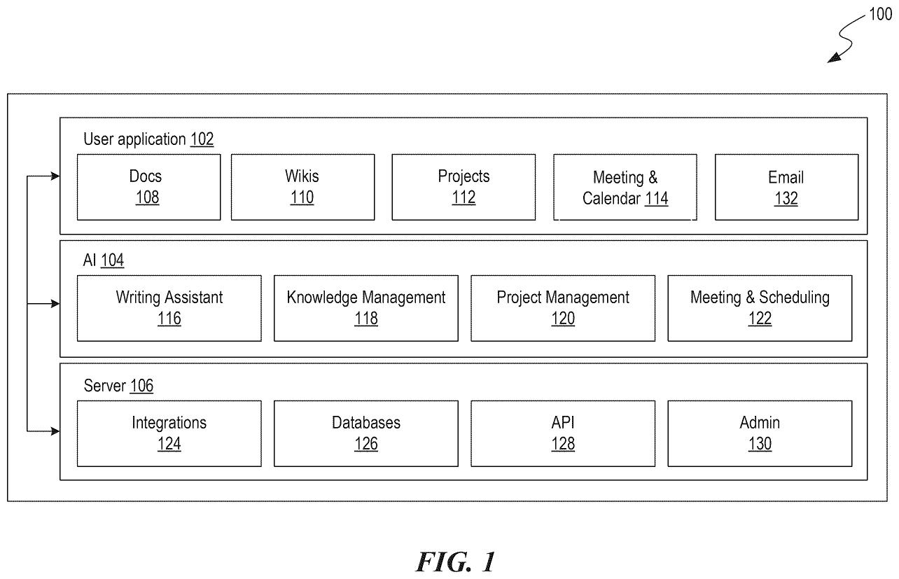

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100, can include an embedding of a document within the platform 100, or an embedding of a block in the document. In another example, a wiki can link to a meeting within the calendar.

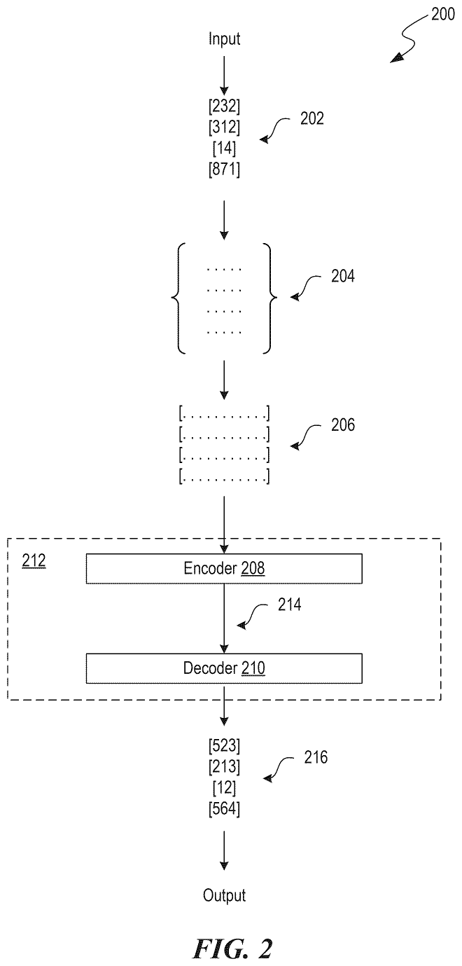

The AI tool 104 is an integrated AI assistant that enables AI-based functions for the user application 102. In one example, the AI tool 104 is based on a neural network architecture, such as the transformer 212 described in FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the databases 126. The integrations unit 124 is a tool connecting the platform 200 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

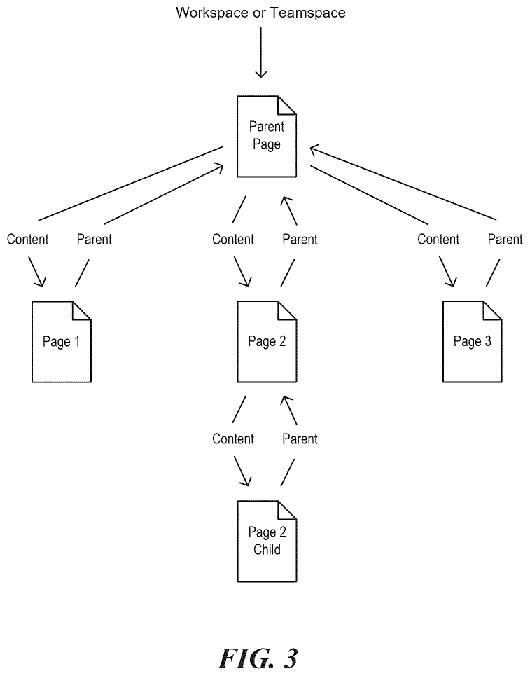

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Database Aggregation

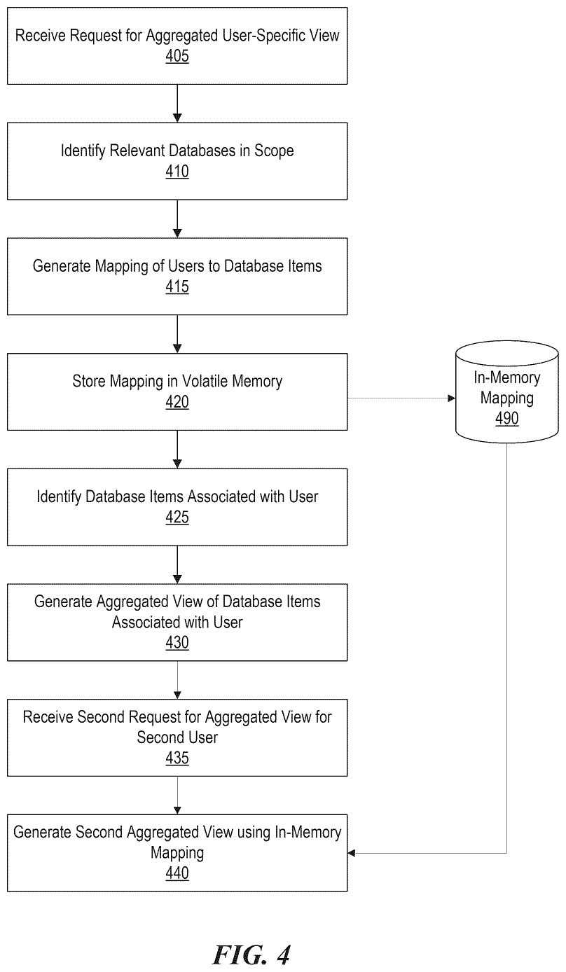

FIG. 4 is a flowchart that illustrates an example process for generating an aggregated view of database items according to some implementations. At operation 405, a platform can receive a request for an aggregated user-specific view (e.g., a view of all a user's tasks across a workspace). At operation 410, the platform can identify relevant databases within a scope. The scope can be a teamspace, multiple teamspaces, a workspace, etc. In some implementations, a default scope is a workspace. At operation 415, the platform can generate a mapping of users to database items. For example, for a workspace with ten users, the platform can, for each of the ten users, map the user to database items associated with the user. At operation 420, the platform can store the mapping in volatile memory (e.g., random access memory (RAM)) as an in-memory mapping 490. At operation 425, the platform can identify database items associated with a particular user, for example by querying the mapping stored in the volatile memory. At operation 430, the platform can generate an aggregated view of database items associated with the user.

One advantage of mapping all users and database items and storing the result in memory is that users who subsequently request an aggregated view do not need to wait for database items to be aggregated, as the aggregation is already stored in memory. This can speed up performance as well as reduce loads on a computer system as prior aggregation data can easily be reused. Moreover, in some implementations, when different users access a workspace, they typically access the same server. Thus, subsequent users are able to take advantage of the in-memory mapping.

At operation 435, the platform can receive a second request for an aggregated view for a second user, such as an aggregated view of tasks assigned to the second user. At operation 440, the platform can generate a second aggregated view for the second user using the in-memory mapping 490.

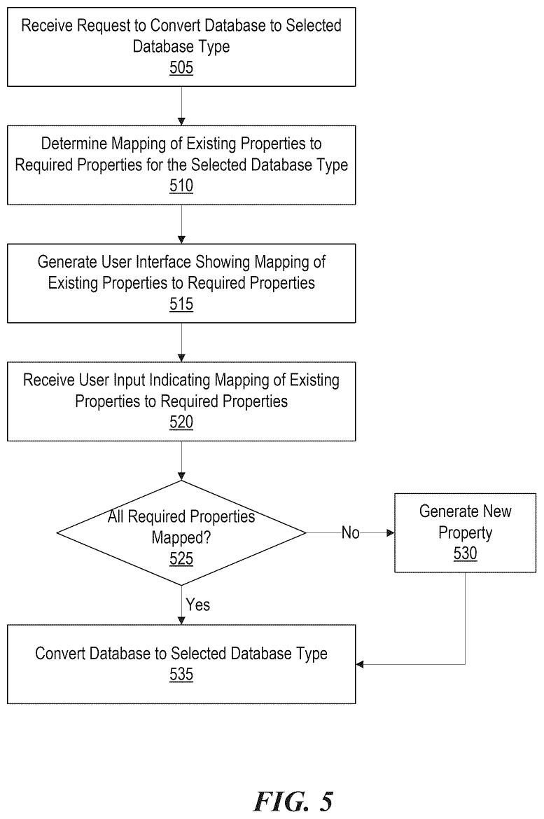

FIG. 5 is a flowchart that illustrates an example process for converting databases according to some implementations. At operation 505, a platform can receive a request to convert a database from one type to another (or from untyped to typed). For example, a user may request that the platform convert a custom database to a task database. In some implementations, the request includes the database type for converting the database. At operation 510, the platform can determine a mapping of existing properties in the database to required properties for the selected database type. For example, the platform can map a “due” property to “due date.” At operation 515, the platform can generate instructions for displaying a user interface showing the mapping of existing properties in the database to required properties of the selected database type. At operation 520, the system can receive a user input indicating a desired mapping of existing properties to required properties. For example, the user can accept the determined mapping or can modify the determined mapping. In some implementations, the platform does not automatically map properties, and the user can manually indicate which properties in the selected database map to the required properties. In some cases, the selected database may not have properties that map to all of the required properties. At operation 525, if not all required properties are mapped, the platform can generate one or more new properties in the selected database. If all required properties are present in the selected database, the system can convert the selected database to the selected database type at operation 535.

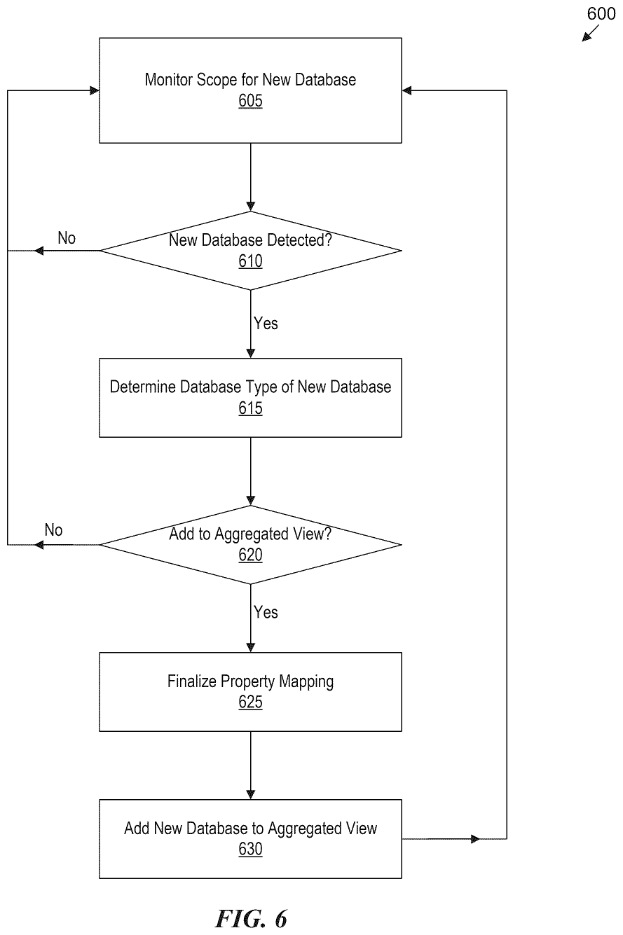

FIG. 6 is a diagram that illustrates an example process for updating a mapping of users and database items according to some implementations. The process 600 can be used to detect the addition of a new database and to add the new database to an aggregated view. At operation 605, a platform can monitor a scope (e.g., a teamspace, workspace, etc.) for a new database. If a new database is not detected at operation 610, the platform can continue monitoring. The monitoring can be continuous or substantially continuous, or can occur periodically (e.g., every minute, hour, day, etc.). In some implementations, a platform can be configured to push a notification or otherwise initiate an action to refresh a mapping when a new database is added, in which case monitoring may not be needed. At operation 615, when there is a new database, the platform can determine a database type for the new database. If the new database is of a type that is included in an aggregated view, the platform can determine a property mapping at operation 625 and add the new database to a corresponding aggregated view at operation 630. In some implementations, operation 625 is skipped when aggregation is based on database type. Adding the new database to the aggregated view at operation 630 can include updating an in-memory mapping used for determining which database items to include in a user-specific aggregated view.

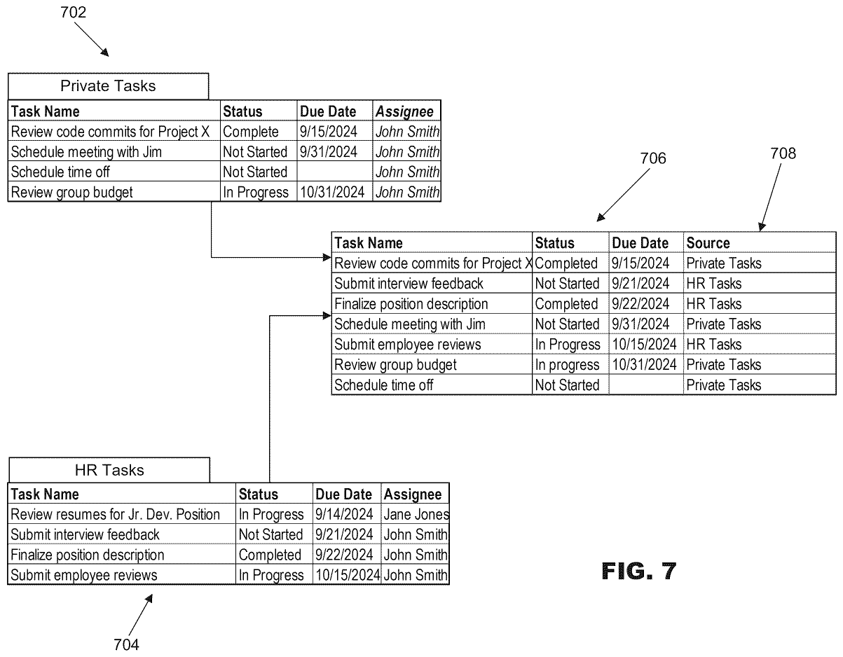

FIG. 7 is a drawing that illustrates an example of user-specific database aggregation according to some implementations. In FIG. 7, a private tasks database 702 and an HR tasks database 704 are aggregated for a user (“John Smith”) into an aggregated view 706. The aggregated view shows only the tasks for the user (“John Smith” in the example of FIG. 7). The private tasks database 702 includes an assignee field that is used for mapping and aggregation but is not shown to the user. The aggregated view 706 includes a source column 708, which indicates the source of each task.

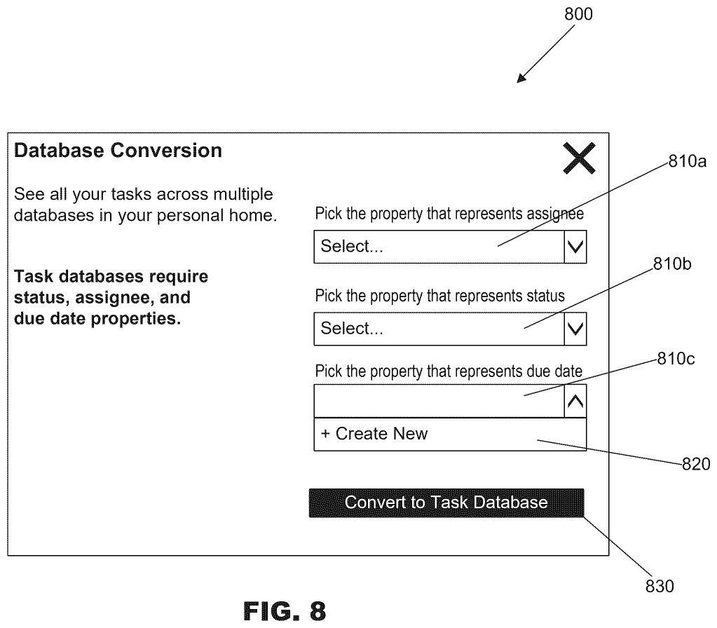

FIG. 8 is a drawing that illustrates an example database conversion user interface according to some implementations. The user interface 800 shows an example database conversion interface for a tasks database that requires status, assignee, and due date properties. The user interface 800 includes user interface elements 810a-810c for specifying which properties in the database to be converted correspond to the required properties. The user interface 800 includes an interface element 820 for adding a new property to the database. For example, if there is no property that maps to “due date” in the database, a user can select the interface element 820 to add a new property that maps to due date. Once a user is satisfied with the mapping, the user can select the button 830 to convert the database. In some implementations, the platform can check data types associated with the properties and can alert the user or otherwise interrupt the conversion process if there is a type mismatch. For example, if a user selects a text property as the due date property, the platform can cause display of an alert (e.g., within the user interface 800 or otherwise) that indicates that the property is not of the correct type for a due date property.

### Computer System

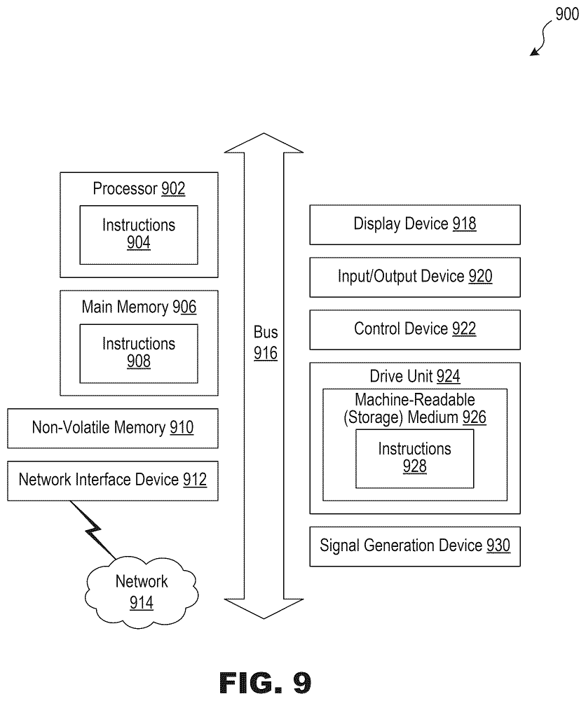

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a display device 918, an input/output device 920, a control device 922 (e.g., keyboard and pointing device), a drive unit 924 that includes a machine readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computer system 900 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 900. In some implementations, the computer system 900 can be an embedded computer system, a system-on-chip (SOC), a single-board computer (SBC) system, or a distributed system such as a mesh of computer systems or include one or more cloud components in one or more networks. Where appropriate, one or more computer systems 900 can perform operations in real time, near real time, or in batch mode.

The network interface device 912 enables the computer system 900 to mediate data in a network 914 with an entity that is external to the computer system 900 through any communication protocol supported by the computer system 900 and the external entity. Examples of the network interface device 912 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computer system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computer system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A computer-implemented method for presenting a user-specific aggregated view of database items in an integrated workspace, the method comprising:
receiving a request for the user-specific aggregated view of database items in the integrated workspace,
wherein the request is associated with a first user of a plurality of users comprising the first user and a second user,
wherein the user-specific aggregated view comprises data from a plurality of databases in the integrated workspace,
wherein each database of the plurality of databases has a first database type,
wherein each database of the plurality of databases has the same first database type,
wherein each database of the plurality of databases comprises a plurality of blocks, and
wherein each block of the plurality of blocks has one or more properties associated therewith;
in response to the request, identifying the plurality of databases in a scope,
wherein the scope is a grouping of hierarchically organized blocks of a render tree;
in response to the request, generating a mapping of the plurality of users to database items in the plurality of databases,
wherein the mapping indicates an association between database items in the plurality of databases and users of the plurality of users;
storing the mapping in volatile memory as an in-memory mapping on a computer system;
generating the user-specific aggregated view for presentation to the first user,
wherein the user-specific aggregated view comprises database items in the plurality of databases that are associated with the first user;
receiving a second request for a second user-specific aggregated view of database items in the integrated workspace,
wherein the second request is associated with the second user of the plurality of users;
identifying a second set of database items using the in-memory mapping,
wherein the second set of database items comprises database items associated with the second user; and
generating, for presentation to the second user, the second user-specific aggregated view,
wherein the second user-specific aggregated view includes the second set of database items.

2. A computer-implemented method for presenting a user-specific aggregated view of database items in an integrated workspace, the method comprising:
receiving a request for the user-specific aggregated view of database items in the integrated workspace,
wherein the user-specific aggregated view comprises database items from a plurality of databases having a same database type in the integrated workspace,
wherein each database item comprises a plurality of properties, and
wherein the request is associated with a first user of a plurality of users;
in response to the request, identifying database items in an in-memory mapping that are associated with the first user,
wherein the in-memory mapping maps users of the plurality of users to database items in the plurality of databases, and
wherein the in-memory mapping is generated in response to a previous request for a user-specific aggregated view of database items associated with a different user of the plurality of users;
generating the user-specific aggregated view for presentation to the first user,
wherein the user-specific aggregated view comprises database items in the plurality of databases that are associated with the first user;
determining a change to a database item in the plurality of databases; and
updating the in-memory mapping in response to the change.

3. The computer-implemented method of claim 1, further comprising:
receiving a request to convert an additional database from a first type to the database type of the plurality of databases;
mapping properties of the additional database to properties associated with the database type;
converting the additional database from the first type to the database type; and
updating the in-memory mapping to include the additional database.

4. The computer-implemented method of claim 2, wherein each database of the plurality of databases comprises data used to populate one or more blocks of an integrated workspace.

5. The computer-implemented method of claim 2, wherein each database of the plurality of databases comprises a plurality of blocks in an integrated workspace, wherein each block of the plurality of blocks comprises one or more properties.

6. The computer-implemented method of claim 4, wherein the user-specific aggregated view includes display of at least one common property.

7. The computer-implemented method of claim 2, wherein each database of the plurality of databases is associated with a scope, wherein the scope is a grouping of hierarchically organized blocks of a render tree.

8. The computer-implemented method of claim 2, further comprising:
detecting a creation of a new database having the same database type as the plurality of databases; and
updating the in-memory mapping to include the new database.

9. The computer-implemented method of claim 8, wherein adding the new database to the user-specific aggregated view comprises updating the in-memory mapping.

10. The computer-implemented method of claim 2, wherein the user-specific aggregated view includes a column indicating a source database of each database item included in the user-specific aggregated view.

11. The computer-implemented method of claim 2, wherein the user-specific aggregated view includes a user interface element that, when selected by a user, causes display of at least one item not shown in the user-specific aggregated view.

12. The computer-implemented method of claim 2, wherein the database type is a task database type, wherein the task database type has core required properties including status, assignee, and due date.

13. A non-transitory, computer-readable storage medium comprising instructions recorded thereon, wherein the instructions, when executed by at least one data processor of a system, cause the system to:
receive a request for a user-specific aggregated view of database items in an integrated workspace,
wherein the user-specific aggregated view comprises database items from a plurality of databases having a same database type in the integrated workspace,
wherein each database item comprises a plurality of properties,
wherein each database of the plurality of databases comprises data used to populate one or more blocks of the integrated workspace, and
wherein the request is associated with a first user of a plurality of users;
in response to the request, identify database items in an in-memory mapping that are associated with the first user,
wherein the in-memory mapping maps users of the plurality of users to database items in the plurality of databases, and
wherein the in-memory mapping is generated in response to a previous request for a user-specific aggregated view of database items associated with a different user of the plurality of users;
generate the user-specific aggregated view for presentation to the first user,
wherein the user-specific aggregated view comprises database items in the plurality of databases that are associated with the first user, and
wherein the user-specific aggregated view includes display of at least one common property;
determine a change to a database item in the plurality of databases; and
update the in-memory mapping in response to the change.

14. The non-transitory, computer-readable storage medium of claim 13, wherein each database of the plurality of databases comprises a plurality of blocks in an integrated workspace, wherein each block of the plurality of blocks comprises one or more properties.

15. The non-transitory, computer-readable storage medium of claim 13, wherein each database of the plurality of databases is associated with a scope, wherein the scope is a grouping of hierarchically organized blocks of a render tree.

16. The non-transitory, computer-readable storage medium of claim 13, wherein the instructions are further configured to, when executed by the at least one data processor, cause the system to:
detect a creation of a new database having the same database type as the plurality of databases; and
update the in-memory mapping to include the new database.

17. The non-transitory, computer-readable storage medium of claim 16, wherein adding the new database to the user-specific aggregated view comprises updating the in-memory mapping.

18. The non-transitory, computer-readable storage medium of claim 13, wherein the user-specific aggregated view includes a column indicating a source database of each database item included in the user-specific aggregated view.

19. The non-transitory, computer-readable storage medium of claim 13, wherein the user-specific aggregated view includes a user interface element that, when selected by a user, causes display of at least one item not shown in the user-specific aggregated view.

20. The non-transitory, computer-readable storage medium of claim 13, wherein the database type is a task database type, wherein the task database type has core required properties including status, assignee, and due date.
